(19) United States
(12) Patent Application Publication
(10) Pub. No.: US 2023/0277006 A1
(43) Pub. Date: Sep. 7, 2023

(54) Food Holding Assembly

(71) Applicant: Jerry Hardeman, Atlanta, GA (US)

(72) Inventor: Jerry Hardeman, Atlanta, GA (US)

(21) Appl. No.: 17/685,971

(22) Filed: Mar. 3, 2022

(51) Int. Cl. A47J 43/18

(52) U.S. Cl. CPC A47J 43/18

(57) ABSTRACT

A food holding assembly for holding finger food includes a pair of toothpicks that is each insertable through a piece of finger food. In this way the toothpicks facilitate a user to hold the finger food for eating. A holder is provided and the holder is curved such that the holder defines an arc of a circle. The holder has a pair of insertion points each integrated into the holder. Furthermore, each of the toothpicks is removably insertable into a respective one of the insertion points such that the holder inhibits the finger food from sliding off of the toothpicks.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to holding devices and more particularly pertains to a new holding device for holding finger food for eating. The device includes a pair of toothpicks and a curved holder. The curved holder has a pair of insertion points each integrated into the curved holder. Additionally, each of the toothpicks is insertable into a respective insertion point. In this way the holder inhibits the finger food from sliding off of the toothpicks.

### (2) Description of Related Art Including Information Disclosed Under 37 CFR 1.97 and 1.98

The prior art relates to holding devices including a toothpick device that includes a spear, a finger extending away from the spear and a panel attached the spear for gripping. The prior art discloses a toothpick device that includes a pointed and a plurality of barbs on the toothpick to inhibit food from sliding off of the toothpick. The prior art discloses a food flavoring container which comprises a hollowed toothpick with a hinged cap. The prior art discloses a food holder which comprises a toothpick and a conical shield that receives the toothpick for capturing fluids that drip from a food item impaled on the toothpick.

### BRIEF SUMMARY OF THE INVENTION

An embodiment of the disclosure meets the needs presented above by generally comprising a pair of toothpicks that is each insertable through a piece of finger food. In this way the toothpicks facilitate a user to hold the finger food for eating. A holder is provided and the holder is curved such that the holder defines an arc of a circle. The holder has a pair of insertion points each integrated into the holder. Furthermore, each of the toothpicks is removably insertable into a respective one of the insertion points such that the holder inhibits the finger food from sliding off of the toothpicks.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a food holding assembly according to an embodiment of the disclosure.

FIG. 2 is a phantom perspective view of an embodiment of the disclosure.

FIG. 3 is a perspective in-use view of an embodiment of the disclosure.

### DETAILED DESCRIPTION OF THE INVENTION

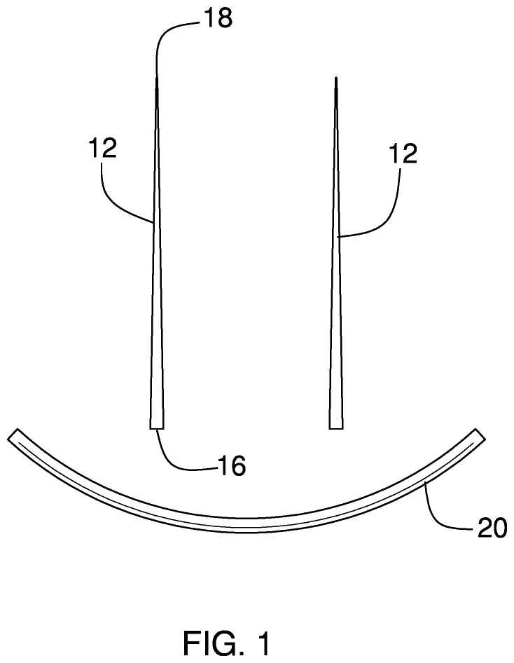

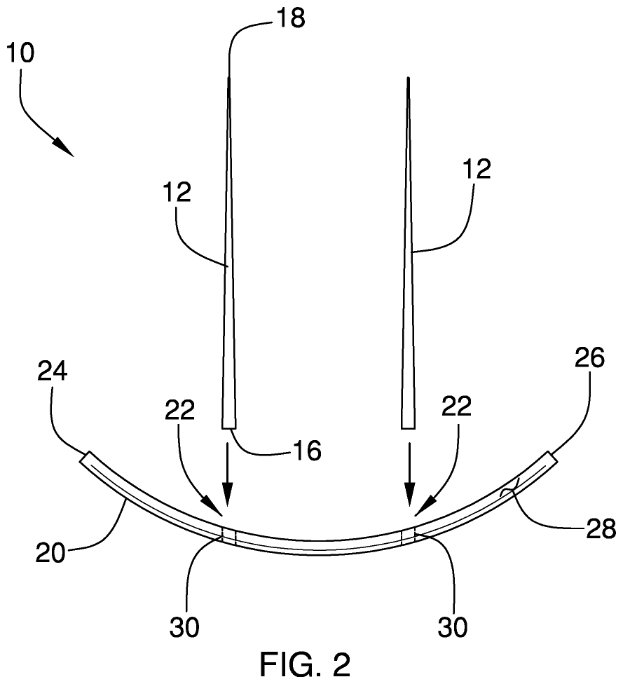

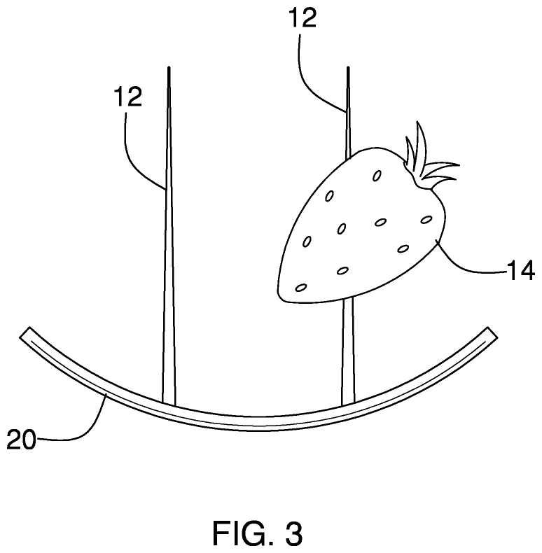

With reference now to the drawings, and in particular to FIGS. 1 through 3 thereof, a new holding device embodying the principles and concepts of an embodiment of the disclosure and generally designated by the reference numeral 10 will be described.

As best illustrated in FIGS. 1 through 3, the food holding assembly 10 generally comprises a pair of toothpicks 12 that is each insertable through a piece of finger food 14 to facilitate a user to hold the finger food 14 for eating. Each of the toothpicks 12 has a lower end 16 and an upper end 18, and the upper end 18 of each of the toothpicks 12 tapers to a point. A holder 20 is provided and the holder 20 is curved such that the holder defines an arc of a circle. The holder 20 has a pair of insertion points 22 that is each integrated into the holder 20. Furthermore, each of the toothpicks 12 is removably insertable into a respective one of the insertion points 22 such that the holder 20 inhibits the finger food 14 from sliding off of the toothpicks 12.

The holder 20 has a first end 24, a second end 26 and an outer surface 28 extending between the first end 24 and the second end 26, and the holder 20 is curved between the first end 24 and the second end 26. The outer surface 28 has a pair of wells each extending into an interior of the holder 20 such that each of the wells 30 defines a respective one of the insertion points 22. The wells 30 are spaced apart from each other and are evenly distributed between the first end 24 and the second end 26. Each of the wells 30 is positioned on an inside of the curve of the holder 20 to facilitate a user to hold the holder 20 having each of the toothpicks 12 extending upwardly from the holder 20. Additionally, each of the wells 30 insertably receives the lower end 16 of the respective toothpick 12. Each of the toothpicks 12 and the holder 20 are comprised of a rigid material, including but not being limited to, wood, plastic, metal or other similar, rigid material.

In use, one or both of the toothpicks 12 is inserted through the finger food 14 and one or both of the toothpicks 12 is insertable into a respective well 30 in the holder 20. In this way the holder 20 inhibits the finger food 14 from sliding off of the toothpick 12. Additionally, the holder 20 can be gripped for eating the finger food 14 from the toothpick 12. The holder 20 and each of the toothpicks 12 can be discarded when the finger food 14 has been eaten.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A food holding assembly for holding finger food, said assembly comprising:
a pair of toothpicks, each of said toothpicks being insertable through a piece of finger food wherein said toothpicks are configured to facilitate a user to hold the finger food for eating; and
a holder being curved such that said holder defines an arc of a circle, said holder having a pair of insertion points each being integrated into said holder, each of said toothpicks being removably insertable into a respective one of said insertion points such that said holder inhibits the finger food from sliding off of said toothpicks.

2. The assembly according to claim 1, wherein said holder has a first end, a second end and an outer surface extending between said first end and said second end, said holder being curved between said first end and said second end, said outer surface having a pair of wells each extending into an interior of said holder such that each of said wells defines a respective one of said insertion points, said wells being spaced apart from each other and being evenly distributed between said first end and said second end.

3. The assembly according to claim 2, wherein each of said wells is positioned on an inside of said curve of said holder wherein said holder is configured to facilitate a user to hold said holder having each of said toothpicks extending upwardly from said holder.

4. The assembly according to claim 2, wherein:
each of said toothpicks has a lower end and an upper end, said upper end of each of said toothpicks tapering to a point; and
each of said wells insertably receives said lower end of said respective toothpick.

5. A food holding assembly for holding finger food, said assembly comprising:
a pair of toothpicks, each of said toothpicks being insertable through a piece of finger food wherein said toothpicks are configured to facilitate a user to hold the finger food for eating, each of said toothpicks having a lower end and an upper end, said upper end of each of said toothpicks tapering to a point; and
a holder being curved such that said holder defines an arc of a circle, said holder having a pair of insertion points each being integrated into said holder, each of said toothpicks being removably insertable into a respective one of said insertion points such that said holder inhibits the finger food from sliding off of said toothpicks, said holder having a first end, a second end and an outer surface extending between said first end and said second end, said holder being curved between said first end and said second end, said outer surface having a pair of wells each extending into an interior of said holder such that each of said wells defines a respective one of said insertion points, said wells being spaced apart from each other and being evenly distributed between said first end and said second end, each of said wells being positioned on an inside of said curve of said holder wherein said holder is configured to facilitate a user to hold said holder having each of said toothpicks extending upwardly from said holder, each of said wells insertably receiving said lower end of said respective toothpick.
